(19) United States
(12) Patent Application Publication
(10) Pub. No.: US 2026/0053190 A1
(43) Pub. Date: Feb. 26, 2026

(54) AEROSOL GENERATING DEVICE

(71) Applicant: KT&G CORPORATION, Daejeon (KR)

(72) Inventors: Hwikyeong AN, Seoul (KR); Sangkyu PARK, Seoul (KR)

(73) Assignee: KT&G CORPORATION, Daejeon (KR)

(21) Appl. No.: 19/106,044

(22) PCT Filed: Aug. 31, 2023
(86) PCT No.: PCT/KR2023/012943

§ 371 Date: Feb. 24, 2025

(30) Foreign Application Priority Data
Sep. 1, 2022 (KR) 10-2022-0110567
Dec. 2, 2022 (KR) 10-2022-0166861

(51) Int. Cl. A24F 40/40; A24F 40/20; A24F 40/85

(52) U.S. Cl. CPC A24F 40/40; A24F 40/20; A24F 40/85

(57) ABSTRACT

An aerosol generating device according to the present disclosure includes: a body shaped to define a first insertion space that is open at a top side of the body; a heater holder comprising a lateral wall and being detachably insertable into the first insertion space; a heater coupled to the heater holder; and an extractor comprising a lateral wall and being detachably insertable into the first insertion space, wherein the lateral wall of the heater holder and the lateral wall of the extractor collectively define a second insertion space that is open at a top side, and are alternately disposed along a circumference of the second insertion space.

### TECHNICAL FIELD

The present disclosure relates to an aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide an aerosol generating device that can improve the heater and power efficiency.

It is yet another objective of the present disclosure to provide an aerosol generating device that can allow a heater to be easily attached/detached or replaced.

It is yet another objective of the present disclosure to reduce overheating of an aerosol generating device.

It is yet another objective of the present disclosure to provide an aerosol generating device that is easy to clean and maintain.

It is yet another objective of the present disclosure to prevent separation of a heater from an aerosol generating device upon insertion of a stick.

It is yet another objective of the present disclosure to prevent rotation of a heater in a circumferential direction.

It is yet another objective of the present disclosure to provide an aerosol generating device with an improved (or increased) heater replacement period.

It is yet another objective of the present disclosure to reduce factors that change the taste of a stick.

It is yet another objective of the present disclosure to provide an aerosol generating device that can allow a stick to be easily removed.

### Solution to Problem

According to one aspect of the subject matter described in this application, an aerosol generating device includes: a body shaped to define a first insertion space that is open at a top side of the body; a heater holder comprising a lateral wall and being detachably insertable into the first insertion space; a heater coupled to the heater holder; and an extractor comprising a lateral wall and being detachably insertable into the first insertion space, wherein the lateral wall of the heater holder and the lateral wall of the extractor collectively define a second insertion space that is open at a top side, and are alternately disposed along a circumference of the second insertion space.

### Advantageous Effects of Invention

According to at least one of the embodiments of the present disclosure, an aerosol generating device that improves the heater and power efficiency may be provided.

According to at least one of the embodiments of the present disclosure, an aerosol generating device that allows a heater to be easily attached/detached or replaced may be provided.

According to at least one of the embodiments of the present disclosure, overheating of an aerosol generating device may be reduced.

According to at least one of the embodiments of the present disclosure, an aerosol generating device that is easy to clean and manage may be provided.

According to at least one of the embodiments of the present disclosure, separation of a heater from an aerosol generating device may be prevented upon insertion of a stick.

According to at least one of the embodiments of the present disclosure, rotation of a heater in a circumferential direction may be prevented.

According to at least one of the embodiments of the present disclosure, an aerosol generating device with an improved (or increased) heater replacement period may be provided.

According to at least one of the embodiments of the present disclosure, factors that change the taste of a stick may be reduced.

According to at least one of the embodiments of the present disclosure, an aerosol generating device that allows a stick to be easily removed may be provided.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 18 illustrate examples of an aerosol generating device according to the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to failitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

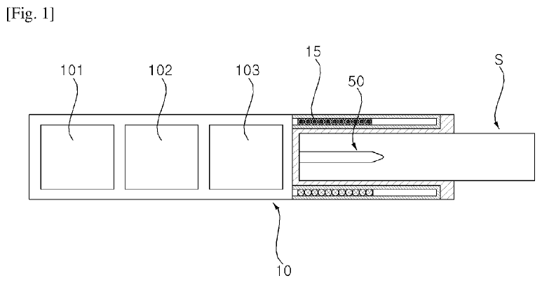

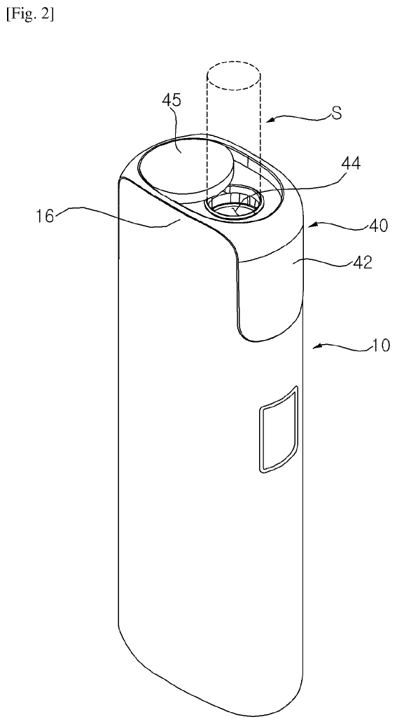

Referring to FIGS. 1 and 2, an aerosol generating device may include at least one of a battery 101, a controller 102, and a sensor 103. At least one of the battery 101, the controller 102, and the sensor 103 may be disposed in a body 10 of the aerosol generating device. The body 10 may provide a space open at the top so as to allow a stick S to be inserted therein. A lower end of the stick S may be inserted into the body 10, and an upper end of the stick S may protrude to an outside of the body 10. A user may inhale air while holding the upper end of the stick S exposed to the outside in his or her mouth.

A heater 50 may heat the stick S. The heater 50 may extend upward in an elongated manner in a space where the stick S is inserted. The heater 50 may be inserted into a lower portion of the stick S. The heater 50 may be a resistive heater.

The battery 101 may supply power to operate components of the aerosol generating device. The battery 101 may supply power to at least one of the controller 102, the sensor 103, an induction coil 15, and the heater 50. The battery 101 may supply power required to operate a display, a motor, and the like, installed at the aerosol generating device.

The controller 102 may control the overall operation of the aerosol generating device. The controller 102 may control the operation of at least one of the battery 101, the induction coil 15, and the sensor 103. The controller 102 may control the operation of the display, the motor, and the like, installed at the aerosol generating device. The controller 102 may check the state of each of the components of the aerosol generating device to determine whether the aerosol generating device is in an operable state.

The sensor 103 may sense a temperature of the heater 50. The controller 102 may control the temperature of the heater 50 based on the temperature of the heater 50 sensed by the sensor 103. The controller 102 may transmit information regarding the temperature of the heater 50, sensed by the sensor 103, to the user through a user interface.

The aerosol generating device may include the induction coil 15 surrounding the heater 50. The induction coil 15 may cause the heater 50 to generate heat. The heater 50, which serves as a susceptor, may generate heat by a magnetic field produced by an AC current flowing through the induction coil 15. The magnetic field may pass through the heater 50 and generate an eddy current in the heater 50. The current may cause heat to be generated in the heater 50. Unlike shown in FIG. 1, the heater 50 may be electrically connected to the battery 101. Without the need for the induction coil 15, the heater 50 may generate heat directly by using a current supplied from the battery 101.

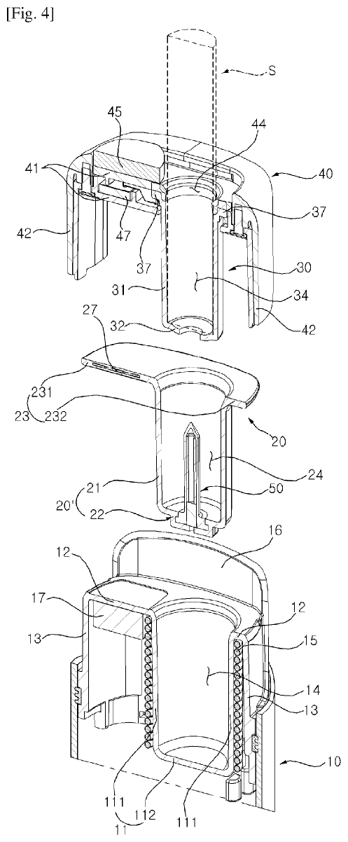

Referring to FIGS. 2 to 4, the body 10 may have a shape elongated vertically. The body 10 may provide a first insertion space 14 therein. The first insertion space 14 may be open at the top. The first insertion space 14 may have a cylindrical shape elongated vertically. The first insertion space 14 may be defined by a body pipe 11 provided in the body 10. The body pipe 11 may include a lateral wall 111 surrounding a circumference of the first insertion space 14 and a lower wall 112 covering a bottom of the first insertion space 14. The lower wall 112 may be formed at a bottom of the body pipe 11. The lateral wall 111 of the body pipe 11 may be referred to as an inner lateral wall 111 of the body 10.

A heater holder 20 may be detachably inserted into the first insertion space 14. The heater holder 20 may provide a second insertion space 24 therein. The second insertion space 24 may be open at the top. The second insertion space 24 may have a cylindrical shape. The second insertion space 24 may be defined by a pipe 20′ of the heater holder 20. The pipe 20′ may include a lateral wall 21 surrounding a circumference of the second insertion space 24 and a lower wall 22 covering a bottom of the second insertion space 24. The lower wall 22 of the pipe 20′ may be referred to as a bottom 22 or a mount 22. The lower wall 22 of the pipe 20′ may define a bottom 22 of the heater holder 20. The heater 50 may be coupled or fixed to the heater holder 20. The pipe 20′ may be referred to as a heater holder pipe 20′.

An extractor 30 may be detachably inserted into the second insertion space 24. The extractor 30 may provide a third insertion space 34 therein. The third insertion space 34 may be open at one side. The third insertion space 34 may have a cylindrical shape. The third insertion space 34 may be defined by a lateral wall 31 and a lower wall 32 of the extractor 30. An outer circumferential surface of the extractor 30 may have a cylindrical shape.

The lower end of the stick S may be inserted into the third insertion space 34, and the upper end of the stick S may protrude to an outside of the aerosol generating device. The heater 50 may heat the first insertion space 14, the second insertion space 24, and the third insertion space 34. The heater 50 may heat the stick S inserted into the third insertion space 34.

Accordingly, the heater 50 may be easily replaced. The replacement of the insertion space 14, 24, 34, and the heater 50 disposed in the insertion space 14, 24, 34 may be difficult due to their small sizes. However, the user may easily replace the heater 50 by removing the heater holder 20 from the aerosol generating device and placing a new heater holder 20 into the aerosol generating device.

In addition, a foreign material (or impurity) generated from the stick S may be extracted through the extractor 30, so that no foreign material remains in the vicinity of the heater 50 and on the heater holder 20. Accordingly, cleaning of the aerosol generating device, namely, near the heater 50 may be easier, and the convenience of management may be improved. Also, a replacement period of the heater 50 may be extended by reducing factors that decrease the performance of the heater 50 and by improving durability of the heater 50. Further, factors that change the taste of the stick S may be reduced.

A lower end of the heater 50 may be fixed to the mount 22. The heater 50 may be elongated toward the opening of the second insertion space 24. The heater 50 may be formed in a cylindrical shape and have a pointed upper end that narrows toward the top. As another example, the heater 50 may have a shape extending in a circumferential direction, and may be coupled to the lateral wall 21 of the heater holder 20. However, this is just an example. The shape of the heater 50 is not limited to those described above or shown in the drawings, and any other shape may be used, so long as the heater 50 can be coupled to the heater holder 20 and heat the stick S inserted into the third insertion space 34.

The heater holder 20 may be insert-injected to the heater 50. The heater holder 20 may have high heat resistance and excellent rigidity. For example, the heater holder 20 may be made of polyetheretherketone (PEEK). However, the material of the heater holder 20 is not limited thereto.

The lower wall 32 of the extractor 30 may be open to define a through-hole 35. The through-hole 35 may be open at the top and the bottom. When the extractor 30 is inserted into the second insertion space 24, the heater 50 may protrude to the third insertion space 34 by passing through the through-hole 35. When the stick S is inserted into the third insertion space 34, the heater 50 may be inserted into the lower portion of the stick S.

The induction coil 15 may surround the first insertion space 14. The induction coil 15 may be wound around the lateral wall 111 of the body pipe 11. The induction coil 15 may surround the heater 50. The induction coil 15 may allow the heater 50 to generate heat. As another example, the heater 50 may generate heat by using power supplied from a power supply source in direct electrical connection therewith through a terminal provided at the heater holder 20.

Accordingly, the stick S may be easily removed from the heater 50. The user may easily remove the stick S from the heater 50 by separating the extractor 30 and the heater holder 20 from each other. As the stick S inserted into the extractor 30 is removed from the heater 50, the stick S may be more easily separated from the extractor 30. The stick S may be removed without separating the extractor 30 and the heater holder 20 from each other.

In addition, a foreign material generated from the stick S may be extracted through the extractor 30, so that no foreign material remains in the vicinity of the heater 50 and on the heater holder 20. Accordingly, cleaning of the aerosol generating device, namely, near the heater 50 may be easier, and the convenience of management may be improved. Also, a replacement period of the heater 50 may be extended by reducing factors that decrease the performance of the heater 50 and by improving durability of the heater 50. Further, factors that change the taste of the stick S may be reduced.

The heater holder 20 may be disposed between the body 10 and the extractor 30. The lateral wall 111 of the body pipe 11 may surround the lateral wall 21 of the heater holder 20. The lower wall 112 of the body pipe 11 may face the lower wall 22 of the heater holder 20. The lateral wall 21 of the heater holder 20 may surround the lateral wall 31 of the extractor 30. The lower wall 22 of the heater holder 20 may face the lower wall 32 of the extractor 30.

The lateral wall 31 of the extractor 30 may be spaced inward from the lateral wall 21 of the heater holder 20. The lower wall 32 of the extractor 30 may be spaced upward from the lower wall 22 of the heater holder 20. Air may flow between the extractor 30 and the heater holder 20, pass through the through-hole 35, and then be delivered to the stick S inserted into the third insertion space 34.

An upper wall 12 of the body 10 may extend outward from an upper end of the body pipe 11 along a horizontal direction. The upper wall 12 of the body 10 may cover an upper end of the induction coil 15. An outer lateral wall 13 of the body 10 may extend downward from an outer end of the upper wall 12 of the body 10. The outer lateral wall 13 of the body 10 may face the lateral wall 111 of the body pipe 11. The outer lateral wall 13 of the body 10 may be spaced outward from the body pipe 11. The induction coil 15 may be disposed between the body pipe 11 and the outer lateral wall 13 of the body 10.

An upper case 40 may be detachably coupled to the body 10. The upper case 40 may be coupled to an upper side of the body 10. The upper case 40 may cover the surrounding of the first insertion space 14 and the surrounding of an upper portion of the body 10. The upper case 40 may have an insertion hole 44. The stick S may be inserted into the insertion hole 44. The upper case 40 may include a cap 45 that opens and closes the insertion hole 44. The cap 45 may slide transversely to open and close the insertion hole 44. The heater holder 20 may be disposed between the body 10 and the upper case 40.

The upper case 40 may include an upper case body 41. The upper case body 41 may be open at the top and the bottom to define the insertion hole 44. The insertion hole 44 may be formed at a position eccentric to one side from a center of the upper case body 41. A lower surface of the upper case body 41 may have a shape corresponding to the upper wall 12 of the body 10. The lower surface of the upper case body 41 may extend in the horizontal direction to be parallel with the upper wall 12 of the body 10. The cap 45 may be installed to be slidable on the upper case body 41.

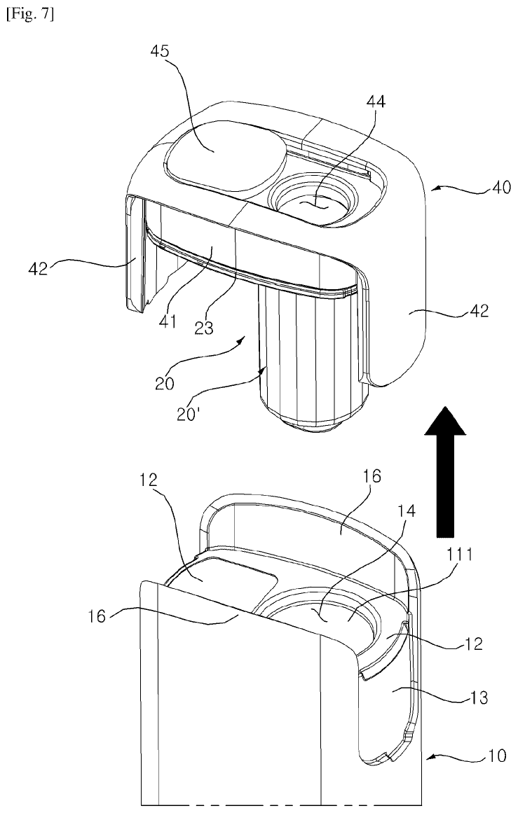

The upper case 40 may include an upper case wing 42. The upper case wing 42 may extend downward from each of both sides of the upper case body 41. A portion of a lateral portion of the upper case body 41 may be exposed between a pair of upper case wings 42 (see FIG. 7). The upper case wing 42 may be referred to as an upper case grip 42.

The extractor 30 may be coupled to the upper case 40. An upper end of the extractor 30 may be coupled to the upper case 40, and a lower end of the extractor 30 may protrude downward of the upper case 40. The extractor 30 may be coupled to a position corresponding to the insertion hole 44. The insertion hole 44 may be located over the third insertion space 34. The insertion hole 44 may allow the third insertion space 34 and the outside of the aerosol generating device to communicate with each other.

The upper end of the extractor 30 may be coupled to the upper case body 41. The extractor 30 may extend downward from the upper case body 41. The extractor 30 may be disposed between the pair of upper case wings 42.

The body 10 may include a body wing 16. The body wing 16 may extend upward from an edge of the upper wall 12 of the body 10. A pair of body wings 16 may be disposed opposite each other with respect to the upper portion of the body 10 (see FIG. 7). The body wing 16 may be formed at a position non-overlapping with the upper case wing 42.

When the upper case 40 is coupled to the body 10, the upper case 40 may define an exterior (or outer appearance) of an upper portion of the aerosol generating device. When the upper case 40 is coupled to the body 10, the body wing 16 may cover the lateral portion of the upper case body 41 exposed between the pair of upper case wings 42. When the upper case 40 is coupled to the body 10, the upper case wing 42 may cover the outer lateral wall 13 of the body 10.

Accordingly, the user may more easily remove the extractor 30 from the body 10. Without the inconvenience of gripping the extractor 30 inserted into the second insertion space 24, the user may remove the extractor 30 by separating the upper case 40 from the body 10 while holding the exterior of the upper case 40. For example, the user may easily remove the upper case 40 and the extractor 30 from the body 10 by holding and pulling the pair of upper case wings 42 from the body 10.

The extractor 30 may include an engaging protrusion 37. The engaging protrusion 37 may protrude outward from an upper outer circumferential surface of the extractor 30 along the horizontal direction. A plurality of engaging protrusions 37 may be provided. The plurality of engaging protrusions 26 may be spaced apart from each other in the circumferential direction. The engaging protrusion 37 may be inserted into and caught in a recess formed in the upper case body 41 near the insertion hole 44, allowing the extractor 30 to be fixed to the upper case 40. The engaging protrusion 37 may be engaged with the upper case body 41 in the circumferential direction.

Accordingly, the extractor 30 may be prevented from being rotated in the circumferential direction with respect to the upper case 40 during insertion and removal of the stick S.

The heater holder 20 may include an extension portion 23. The extension portion 23 may be formed at an upper end of the heater holder 20. The extension portion 23 may extend outward from an upper end of the pipe 20′ along the horizontal direction. The extension portion 23 may have a plate shape. One side of the extension portion 23 may be longer with respect to the pipe 20′. The extension portion 23 may be referred to as a heater holder extension portion 23.

The extension portion 23 may have a shape corresponding to the upper wall 12 of the body 10. The extension portion 23 may be formed horizontally to the upper wall 12 of the body 10. When the pipe 20′ is inserted into the first insertion space 14, the extension portion 23 may be supported or seated on the upper wall 12 of the body 10. The upper wall 12 of the body 10 may support the extension portion 23, and the extension portion 23 may support the pipe 20′. The pipe 20′ may be spaced upward from the lower wall 112 of the body pipe 11 while hanging on the extension portion 23, thereby forming an air gap. An outer circumferential surface of the pipe 20′ may be spaced inward from the lateral wall 111 of the body pipe 11 to form an air gap.

The extension portion 23 may have a shape corresponding to the lower surface of the upper case body 41. The extension portion 23 may be formed horizontally to the lower surface of the upper case body 41. When the upper case 40 is coupled to the body 10, the extractor 30 may be inserted into the pipe 20′, allowing the extension portion 23 to be in contact with the lower surface of the upper case body 41.

A first coupling member 27 may be fixed to the heater holder 20. For example, the first coupling member 27 may be fixed to the extension portion 23. The first coupling member 27 may be fixed to an inner or outer surface of the extension portion 23. The heater holder 20 may be insert-injected to the first coupling member 27 and the heater 50.

The extension portion 23 may include a first extension portion 231 and a second extension portion 232. The first extension portion 231 may extend from the pipe 20′ to one side, and the second extension portion 232 may extend from the pipe 20′ to another side. The first extension portion 231 may extend longer than the second extension portion 232. A circumference of the first extension portion 231 may be greater than a circumference of the second extension portion 232. The first extension portion 231 may be wider in the horizontal direction than the second extension portion 232. With respect to the pipe 20′ extending downward from the extension portion 23 of the plate shape, one side may be defined as the first extension portion 231 and another side may be defined as the second extension portion 232. The pipe 20′ may extend downward from a portion eccentric to one side from a center of the extension portion 23.

Of the portions of the extension portion 23, the first coupling member 27 may be fixed to the first extension portion 231 extending longer to one side with respect to the pipe 20′. The first coupling member 27 may have a plate shape. The first coupling member 27 may be widely disposed at the first extension portion 23 in the horizontal direction. The position at which the first coupling member 27 is disposed is not limited thereto. For example, the first coupling member 27 may be fixed to the pipe 20′.

The first coupling member 27 may be made of a magnetic material. The first coupling member 27 may be ferromagnetic. For example, the first coupling member 27 may be made of stainless steel. However, the material of the first coupling member 27 is not limited thereto.

A second coupling member 47 may be fixed to the upper case 40. The second coupling member 47 may be fixed inside the upper case body 41. The second coupling member 47 may be adjacent to the lower surface of the upper case body 41. However, the position at which the second coupling member 47 is disposed is not limited thereto. For example, the second coupling member 47 may be fixed to the upper case wing 42. As another example, the second coupling member 47 may be fixed to the extractor 30. The second coupling member 47 may be disposed at a position corresponding to the first coupling member 27.

An attractive force may act between the second coupling member 47 and the first coupling member 27. For example, the first coupling member 27 may be a ferromagnetic material, and the second coupling member 47 may be a magnet. However, the material of the first coupling member 27 and the material of second coupling member 47 are not limited thereto.

A third coupling member 17 may be fixed inside the body 10. The third coupling member 17 may be adjacent to the upper wall 12 of the body 10. The third coupling member 17 may be disposed at a position corresponding to the first coupling member 27. However, the position at which the third coupling member 17 is disposed is not limited thereto. For example, the third coupling member 17 may be adjacent to the lateral wall 111 of the body pipe 11. An attractive force may act between the third coupling member 17 and the first coupling member 27. For example, the first coupling member 27 may be a ferromagnetic material, and the third coupling member 17 may be a magnet. However, the material of the first coupling member 27 and the material of the third coupling member 17 are not limited thereto.

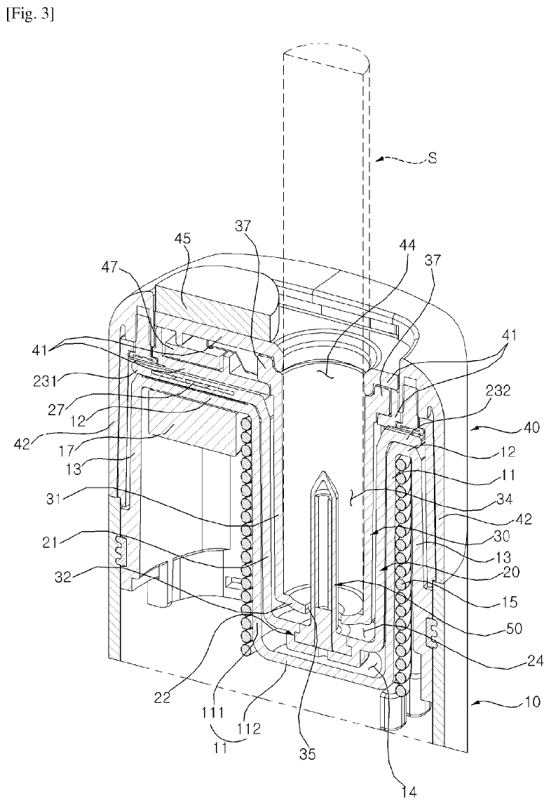

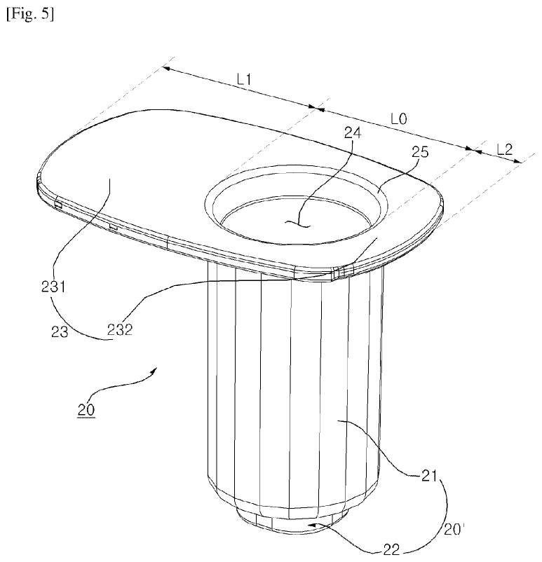

Referring to FIG. 5, an outer circumferential surface of the lateral wall 21 of the pipe 20′ may form a plurality of angles in the circumferential direction. A transverse plane or section of the outer circumferential surface of the lateral wall 21 of the pipe 20′ may have a polygonal shape. The outer circumferential surface of the lateral wall 21 of the pipe 20′ may be elongated vertically, and may include a plurality of surfaces arranged at an angle to each other along the circumferential direction. The outer circumferential surface of the pipe 20′ may be spaced inward from the lateral wall 111 of the body pipe 11 so as to form an air gap (see FIG. 3). The heater 50 may be surrounded by the extractor 30 and the pipe 20′. The extractor 30 and the pipe 20′ may be spaced apart from each other to form an air gap.

Accordingly, the amount of heat, which is generated from the heater 50, transferred to the body pipe 11 (see FIG. 3) through the pipe 20′ may be reduced, thereby reducing overheating of the aerosol generating device.

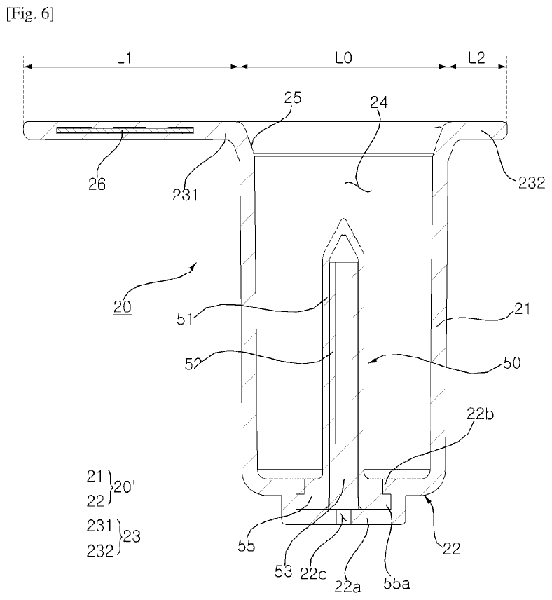

Referring to FIG. 6, a guide portion 25 may be formed on an upper inner circumferential surface of the pipe 20′. The guide portion 25 may be disposed between the pipe 20′ and the extension portion 23. The guide portion 25 may be in contact with the opening of the second insertion space 24. The guide portion 25 may be inclined downward. The guide portion 25 may extend in the circumferential direction to surround the opening of the second insertion space 24.

Accordingly, the guide portion 25 may come in contact with a lower portion of the extractor 30, thereby guiding the extractor 30 to be easily inserted into the second insertion space 24.

The lower end of the heater 50 may be inserted into and fixed to the mount 22. The heater 50 may include a heater rod 51. The heater rod 51 may define an exterior of the heater 50. The heater rod 51 may be elongated vertically. The heater rod 51 may have a cylindrical shape. The heater rod 51 may be provided therein with a hollow open at the bottom. The hollow may be elongated vertically. The hollow of the heater rod 51 may have a cylindrical shape. The heater rod 51 may have a pointed upper end that narrows toward the top. The heater rod 51 may have high thermal expandability, excellent thermal insulation, and low thermal conductivity. The heater rod 51 may have high rigidity. For example, the heater rod 51 may be made of zirconia. However, the material of the heater rod 51 is not limited thereto.

The heater 50 may include a heating portion 52. The heating portion 52 may be inserted into the hollow of the heater rod 51. The heating portion 52 may be elongated vertically. The heating portion 52 may have a cylindrical shape. The heating portion 52 may be made of a resistive metal. Heat generated from the heating portion 52 may be transferred to an outside of the heater 50 through the heater rod 51. The heating portion 52 may be disposed at a height corresponding to the third insertion space 34 (see FIG. 3). A lower end of the heating portion 52 may be adjacent to a lower end of the through-hole 35.

The heater 50 may include a support 53. The support 53 may be inserted into the hollow of the heater rod 51. The support 53 may be disposed under the heating portion 52. The support 53 may be fixed to the heater rod 51 in the hollow. The support 53 may support a lower portion of the heating portion 52. A lower end of the support 53 may be supported by a bottom 22a of the mount 22. A hole 22c that is disposed at a center of the mount 22 may be formed by the process of insert-injecting the heater holder 20. A width of the hole 22c may be less than a width of the support 53 to thereby prevent separation of the support 53. The hole 22c may be excluded. The support 53 may have high heat resistance. The support 53 may not be thermally deformed by heat generated by the heating portion 52. The support 53 may be made of polyamide. However, the material of the support 53 is not limited thereto.

The heater 50 may include a flange 55. The flange 55 may be formed at a lower end of the heater rod 51. The flange 55 may extend outward from an outer circumferential surface of the lower end of the heater rod 51 along the horizontal direction. The flange 55 may extend in a circumferential direction of the heater rod 51. The lower end of the heater rod 51 and the flange 55 may be inserted into the mount 22. As the heater holder 20 is insert-injected to the heater 50, the mount 22 may be integrally coupled to the flange 55.

A transverse section of an outer circumferential surface of the flange 55 may have a non-circular shape. An inner circumferential surface of the mount 22 may have a shape corresponding to the outer circumferential surface of the flange 55. The inner circumferential surface of the mount 22 and the outer circumferential surface of the flange 55 may be engaged with each other in the circumferential direction. Accordingly, the heater 50 may be prevented from being rotated in the circumferential direction with respect to the heater holder 20 when the stick S is inserted into or removed from the heater 50.

The flange 55 may include a first engaging portion 55a. The first engaging portion 55a may protrude outward from a circumference of the flange 55. The first engaging portion 55a may be formed at a lower portion of the flange 55. The first engaging portion 55a may extend along the circumference of the flange 55.

The mount 22 may include a second engaging portion 22b. The second engaging portion 22b may protrude inward toward a recess of the mount 22. The second engaging portion 22b may have a shape corresponding to the first engaging portion 55a. The first engaging portion 55a may be disposed under the second engaging portion 22b. The first engaging portion 55a and the second engaging portion 22b may overlap vertically. The second engaging portion 22b may support the first engaging portion 55a, thereby preventing the flange 55 from being separated upward from the mount 22.

The extension portion 23 may extend longer to one side with respect to the pipe 20′ or the second insertion space 24. With respect to one horizontal direction, a length L1 of the first extension portion 231 may be greater than a length L2 of the second extension portion 232. The length L1 of the first extension portion 231 may be greater than a diameter L0 of the second insertion space 24. Alternatively, the length L1 of the first extension portion 231 may be closer to the diameter L0 of the second insertion space 24 than the length L2 of the second extension portion 232. The first coupling member 27 may have a plate shape. The first coupling member 27 may be horizontally fixed to the first extension portion 231.

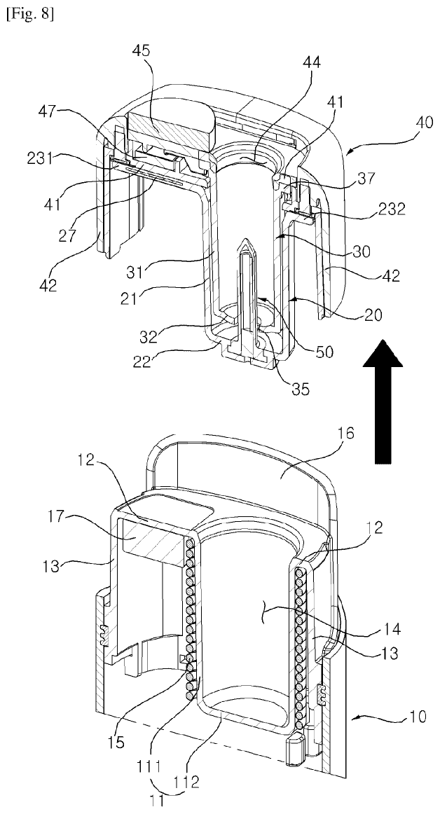

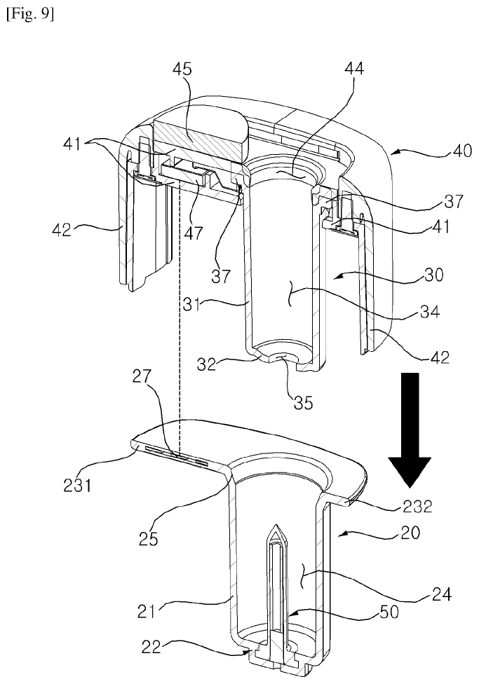

Referring to FIGS. 7 to 9, the upper case 40 may be detached from the body 10. The heater holder 20 may be detachably coupled to the upper case 40. When the upper case 40 is detached from the body 10, the heater holder 20 may be removed together with the upper case 40 from the body 10 while being coupled to the upper case 40. In a state where the upper case 40 to which the heater holder 20 is coupled is separated from the body 10, the heater holder 20 may be detached from the upper case 40.

In another example, the heater holder 20 may be detachably coupled to the extractor 30. When the extractor 30 is detached from the body 10, the heater holder 20 may be removed together with the extractor 30 from the body 10 while being coupled to the extractor 30. In a state where the extractor 30 to which the heater holder 20 is coupled is separated from the body 10, the heater holder 20 may be detached from the extractor 30.

The first coupling member 27 and the second coupling member 47 may exert an attractive force on each other. The first coupling member 27 and the second coupling member 47 may allow the heater holder 20 to be detachably coupled to the upper case 40 and/or the extractor 30. In one example, the first coupling member 27 and the second coupling member 47 may be magnets that attract each other. In another example, one of the first coupling member 27 and the second coupling member 47 may be a ferromagnetic material, and the other may be a magnet. However, without being limited to those described above, any other configuration may be used, so long as the first coupling member 27 and the second coupling member 47 attract each other through an electric force or a magnetic force.

The extension portion 23 may define a horizontal surface corresponding to the lower surface of the upper case body 41. The first extension portion 231 may define a horizontal surface corresponding to the lower surface of the upper case body 41. An upper surface of the extension portion 23 may be horizontally supported by the upper case body 41. An area supported by the upper case body 41 may be greater in the first extension portion 231 than in the second extension portion 232.

The first coupling member 27 may have a plate shape. The first coupling member 27 may be horizontally fixed to the first extension portion 231. The second coupling member 47 may be disposed adjacent to the lower surface of the upper case body 41. The second coupling member 47 may be formed at a position corresponding to the first coupling member 27. Due to the attractive force acting between the first coupling member 27 and the second coupling member 47, the first extension portion 231 may come in contact with the lower surface of the upper case body 41.

In another example, the heater holder 20 may be detachably coupled to the upper case 40 by a screw coupling. In this case, the heater holder 20 may be rotated in the circumferential direction so that the heater holder 20 is removed from or coupled to the upper case 40 by the screw coupling. Alternatively, the heater holder 20 and the upper case 40 may be detachably coupled to each other using a fastening screw. In another example, the heater holder 20 may be detachably coupled to the upper case 40 by a snap-fit coupling. In this case, one of the heater holder 20 and the upper case 40 may have a coupling hook, and the other may have a recess to which the hook is coupled. However, this is just an example, and the method of detachably coupling the heater holder 20 to the upper case 40 is not limited to those described above. The heater holder 20 may be detachably coupled to the upper case 40 in various known methods.

The heater holder 20 that is coupled to the upper case 40 may protrude downward from the upper case 40. The heater holder 20 may be disposed between the pair of upper case wings 42. The pipe 20′ may protrude downward from the upper case body 41 in a manner of protruding downward further than the upper case wing 42. This may make it easier to hold the heater holder 20.

Accordingly, the heater holder 20 may not only be easily detached from the upper case 40 but may also be securely coupled to the upper case 40. In addition, the heater 50 may be conveniently replaced.

Further, the stick S may be easily removed from the heater 50. The user may easily remove the stick S from the heater 50 by separating the extractor 30 and the heater holder 20 from each other. As the stick S inserted into the extractor 30 is separated from the heater 50, the stick S may be more easily removed from the extractor 30.

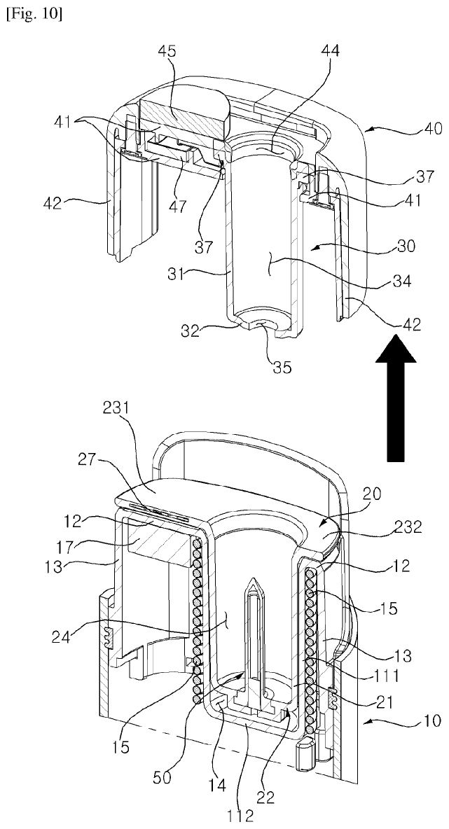

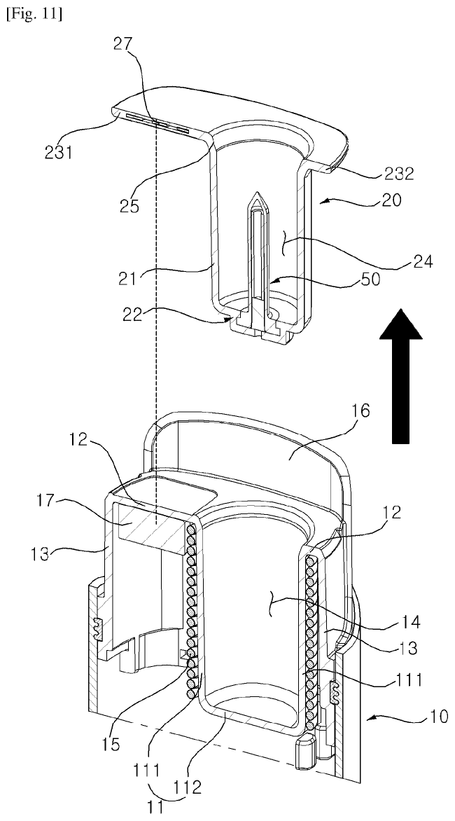

Referring to FIGS. 10 and 11, the heater holder 20 may be detachably coupled to the body 10. In a state where the heater holder 20 is coupled to the body 10, the upper case 40 and/or the extractor 30 may be detached from the body 10 and the heater holder 20. The heater holder 20 may be detached from the body 10 with the upper case 40 and/or the extractor 30 being removed from the body 10 and the heater holder 20.

The first coupling member 27 and the third coupling member 17 may exert an attractive force on each other. The first coupling member 27 and the third coupling member 17 may allow the heater holder 20 to be detachably coupled to the body 10. In one example, the first coupling member 27 and the third coupling member 17 may be magnets that attract each other. In another example, one of the first coupling member 27 and the third coupling member 17 may be a ferromagnetic material, and the other may be a magnet. However, it is not limited to those described above, and any other configuration may be used, so long as the first coupling member 27 and the third coupling member 17 attract each other through an electric force or a magnetic force.

The extension portion 23 may cover the upper wall 12 of the body 10, and the pipe 20′ may be inserted into the first insertion space 14. The extension portion 23 may define a horizontal surface corresponding to the upper wall 12 of the body 10. The first extension portion 231 may correspond to the upper wall 12 of one side of the body 10, and the second extension portion 232 may correspond to the upper wall 12 of another side of the body 10. The lower surface of the extension portion 23 may be horizontally supported by the upper wall 12 of the body 10. An area supported by the body 10 may be greater in the first extension portion 231 than in the second extension portion 232.

The first coupling member 27 may have a plate shape. The first coupling member 27 may be horizontally fixed to the first extension portion 231. The third coupling member 17 may be disposed adjacent to the upper wall 12 of the body 10. The third coupling member 17 may be formed at a position corresponding to the first coupling member 27. The first coupling member 27 may be disposed at the first extension portion 231, and the third coupling member 17 may be disposed adjacent to the upper wall 12 of one side of the body 10 covered by the first extension portion 231. Due to the attractive force acting between the first coupling member 27 and the third coupling member 47, the first extension portion 231 may come in contact with the upper wall 12 of the body 10.

In another example, the heater holder 20 may be detachably coupled to the body 10 by a screw coupling. In this case, the heater holder 20 may be rotated in the circumferential direction so that the heater holder 20 is removed from or coupled to the body 10 by the screw coupling. Alternatively, the heater holder 20 and the body 10 may be detachably coupled to each other using a fastening screw. In another example, the heater holder 20 may be detachably coupled to the body 10 by a snap-fit coupling. In this case, one of the heater holder 20 and the body 10 may have a coupling hook, and the other may have a recess to which the hook is coupled. However, this is just an example, and the method of detachably coupling the heater holder 20 to the body 10 is not limited to those described above. The heater holder 20 may be detachably coupled to the body 10 in various known methods.

The extension portion 23 that is coupled to the body 10 may be exposed upward from the body 10. The extension portion 23 may be disposed between the pair of body wings 16. The extension portion 23 may be disposed adjacent to the outer lateral wall 13 of the body 10 or disposed at a position vertically parallel to the outer lateral wall 13 between the pair of body wings 16. This may make it easier to hold the heater holder 20.

Accordingly, the heater holder 20 may not only be easily detached from the body 10 but may also be securely coupled to the body 10. In addition, the heater 50 may be conveniently replaced.

Further, the stick S may be easily removed from the heater 50. The user may easily remove the stick S from the heater 50 by separating the extractor 30 and the heater holder 20 from each other. As the stick S inserted into the extractor 30 is separated from the heater 50, the stick S may be more easily removed from the extractor 30.

The first coupling member 27 may be disposed between the second coupling member 47 and the third coupling member 17. The first coupling member 27 and the second coupling member 47 may exert an attractive force on each other, and the first coupling member 27 and the third coupling member 17 may exert an attractive force on each other. For example, each of the second coupling member 47 and the third coupling member 17 may be a magnet, and the first coupling member 27 may be a magnet that exerts an attractive force on each of the second coupling member 47 and the third coupling member 17 between the second coupling member 47 and the third coupling member 17. In another example, the first coupling member 27 may be a ferromagnetic material, and each of the second coupling member 47 and the third coupling member 17 may be a magnet. However, without being limited to those described above, any other configuration may be used, so long as the first coupling member 27 and the second coupling member 47 attract each other and the first coupling member 27 and the third coupling member 17 attract each other through an electric force or a magnetic force.

Accordingly, the user may selectively couple the heater holder 20 to any one of the body 10 or the extractor 30 with the upper case 40 and/or the extractor 30 being removed from the body 10. In addition, the upper case 40 and/or the extractor 30 may be more easily and securely coupled to the body 10.

The attractive force between the first coupling member 27 and the second coupling member 47, and the attractive force between the first coupling member 27 and the third coupling member 17 may be different from each other. For example, the attractive force between the first coupling member 27 and the second coupling member 47 may be greater than the attractive force between the first coupling member 27 and the third coupling member 17.

Accordingly, when detaching the upper case 40 and/or the extractor 30 from the body 10, the heater holder 20 may be removed together from the body 10. In addition, when coupling the upper case 40 and/or the extractor 30 to the body 10 while the heater holder 20 is coupled to the upper case 40 and/or the extractor 30, the upper case 40 may be more easily coupled to the body 10 and maintain a more stable coupling state due to the attractive force between the first coupling member 27 and the third coupling member 17.

In another example, the attractive force between the first coupling member 27 and the third coupling member 17 may be greater than the attractive force between the first coupling member 27 and the second coupling member 47. Accordingly, when detaching the upper case 40 and/or the extractor 30 from the body 10, the heater holder 20 may remain coupled to the body 10, and the stick S may be more easily removed from the extractor 30 by being separated from the heater 50.

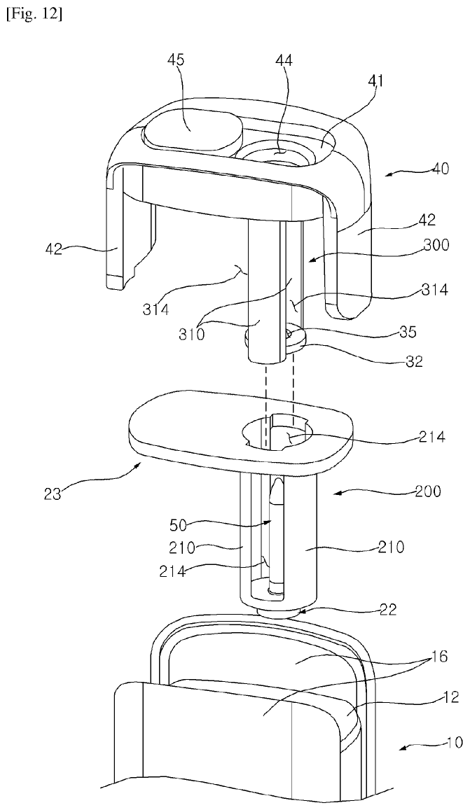

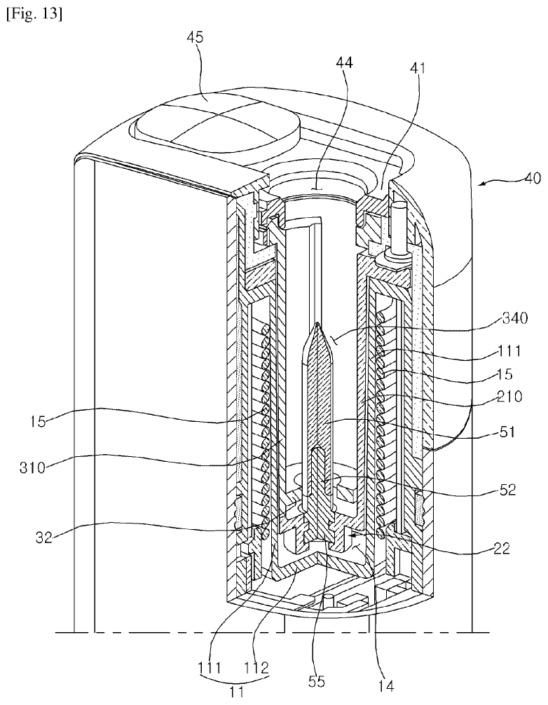

Referring to FIGS. 12 to 14, a lateral wall 210 of a heater holder 200 and a lateral wall 310 of an extractor 300 together may define a fourth insertion space 340 that is open at top. The lateral wall 210 of the heater holder 200 and the lateral wall 310 of the extractor 300 may each cover at least one side of the fourth insertion space 340. The lateral wall 210 of the heater holder 200 and the lateral wall 310 of the extractor 300 together may define a lateral circumference of the fourth insertion space 340.

The lateral wall 210 of the heater holder 200 may be elongated up and down or vertically. The lateral wall 310 of the extractor 300 may be elongated vertically. The lateral wall 210 of the heater holder 200 and the lateral wall 310 of the extractor 300 may be spaced apart from a center of the fourth insertion space 340 in a radial direction by the same distance. The lateral wall 210 of the heater holder 200 and the lateral wall 310 of the extractor 300 may be located on the same extension line of a circumference of the fourth insertion space 340. The lateral wall 210 of the heater holder 200 and the lateral wall 310 of the extractor 300 may each extend in a curved manner in a circumferential direction along the circumference of the fourth insertion space 340.

In one implementation, a plurality of lateral walls 210 of the heater holder 200 may be arranged along a circumference of a lower wall 22 of the heater holder 200. A plurality of slits 214 that are open at top and elongated vertically may be formed at intervals between the plurality of lateral walls 210 of the heater holder 200. The plurality of lateral walls 210 and the plurality of first slits 214 of the heater holder 200 may be alternately arranged in the circumferential direction along the circumference of the fourth insertion space 340.

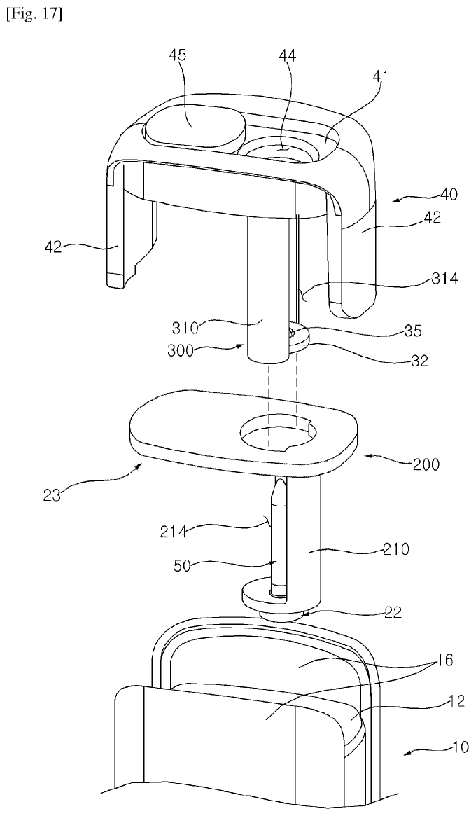

For example, two lateral walls 210 of the heater holder 200 may be provided to be disposed opposite each other with respect to the fourth insertion space 340. Two first slits 214 that are disposed opposite each other with respect to the fourth insertion space 340 may be formed between the two lateral walls 210 of the heater holder 200. However, the number of lateral walls 210 and first slits 214 of the heater holder 200 is not limited thereto, and may be singular (see FIG. 17), or three or more.

In one implementation, a plurality of lateral walls 310 of the extractor 300 may be arranged along a circumference of a lower wall 32 of the extractor 300. A plurality of second slits 314 that are elongated vertically may be formed at intervals between the plurality of lateral walls 310 of the extractor 300. The plurality of lateral walls 310 and the plurality of second slits 314 of the extractor 300 may be alternately arranged in the circumferential direction along the circumference of the fourth insertion space 340.

For example, two lateral walls 310 of the extractor 300 may be provided to be disposed opposite each other with respect to the fourth insertion space 340. Two second slits 314 that are disposed opposite each other with respect to the fourth insertion space 340 may be formed between the two lateral walls 310 of the extractor 300. However, the number of lateral walls 310 and second slits 314 of the extractor 300 is not limited thereto, and may be singular (see FIG. 17), or three or more.

The extractor 300 may be inserted into the heater holder 200. When the extractor 300 is inserted into the heater holder 200, the lateral wall 210 of the heater holder 200 may be disposed in the second slit 314, and the lateral wall 310 of the extractor 300 may be disposed in the first slit 214.

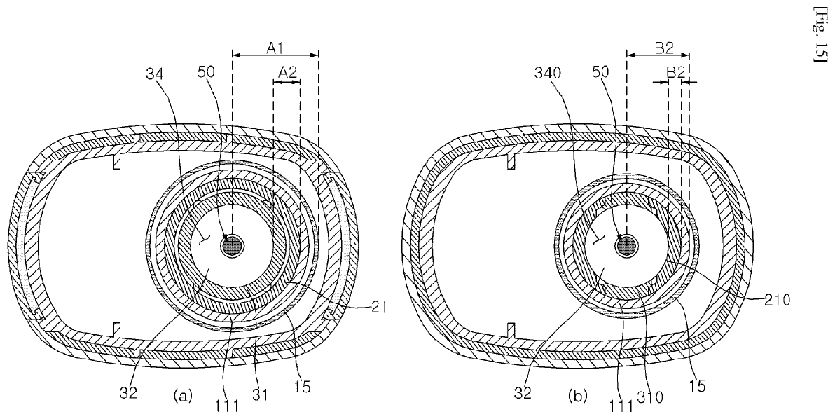

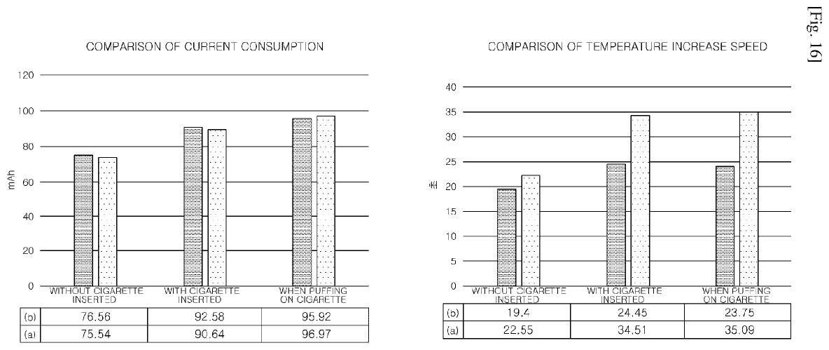

Accordingly, the lateral wall 210 of the heater holder 200 and the lateral wall 310 of the extractor 300 may define the fourth insertion space 340. In addition, a thickness of a wall between an induction coil 15 and a heater 50 may be reduced, thereby improving the heating efficiency of the heater 50. This will be described in detail later with reference to FIGS. 15 and 16.

The lower wall 32 of the extractor 300 may cover a lower portion of the fourth insertion space 340. The lower wall 22 of the heater holder 200 may be disposed below the lower wall 32 of the extractor 300, so as to cover a lower side of the lower wall 32 of the extractor 300. The heater 50 that is fixed to the lower wall 22 of the heater holder 200 and protrudes therefrom may be exposed to the fourth insertion space 340 through a through-hole 35 formed in the lower wall 32 of the extractor 300.

The lower wall 22 of the heater holder 200 may be spaced upward from a lower wall 112 of a body pipe 11. An air gap may be formed between the lower wall 22 of the heater holder 200 and the lower wall 112 of the body pipe 11. The lower wall 32 of the extractor 300 may be spaced upward from the lower wall 22 of the heater holder 200. An air gap may be formed between the lower wall 32 of the extractor 300 and the lower wall 22 of the heater holder 200. Some of heat generated from the heater 50 may be transferred from the lower wall 22 to the lateral wall 210 of the heater holder 200 and then be transferred to the lower wall 112 and a lateral wall 111 of the body pipe 11, allowing the heat to be dissipated. In addition, some of heat generated from the heater 50 may be dissipated through an air gap formed between the heater holder 200 and the extractor 300 around the heater 50.

Accordingly, the amount of heat conducted from the heater 50 to the components in the aerosol generating device may be reduced, thereby preventing a breakdown or mal-function of the aerosol generating device. In addition, the amount of heat conducted from the heater 50 to an outside of the aerosol generating device may be reduced, thereby reducing heat transfer to a user.

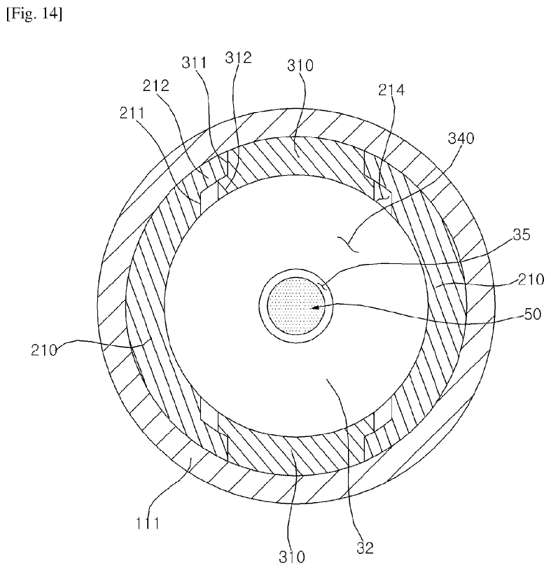

Referring to FIG. 14, the lateral wall 210 of the heater holder 200 and the lateral wall 310 of the extractor 300 may be engaged in the radial direction. The lateral wall 210 of the heater holder 200 and the lateral wall 310 of the extractor 300 may support each other in radially inward and outward directions.

Accordingly, the heater holder 200 and the extractor 300 may be securely positioned without being shaken or displaced from each other in the radial direction.

For example, each lateral wall 210 of the heater holder 200 may include a first recessed portion 211 recessed from opposite end portions 212 thereof in the circumferential direction. The opposite end portions 212 of each lateral wall 210 of the heater holder 200 may protrude further than the first recessed portion 211 in the circumferential direction. The first recessed portion 211 may be formed on an inner circumferential surface side of the lateral wall 210 of the heater holder 200. Alternatively, the first recessed portion 211 may be formed on an outer circumferential surface side of the lateral wall 210 of the heater holder 200. The end portion 212 of the lateral wall 210 of the heater holder 200 may be referred to as a first protrusion portion 212.

Each lateral wall 310 of the extractor 300 may include a second recessed portion 311 recessed from opposite end portions 312 thereof in the circumferential direction. The opposite end portions 312 of each lateral wall 310 of the extractor 300 may protrude further than the second recessed portion 311 in the circumferential direction. The second recessed portion 311 may be formed on an outer circumferential surface side of the lateral wall 310 of the extractor 300. Alternatively, the second recessed portion 311 may be formed on an inner circumferential surface side of the lateral wall 310 of the extractor 300. The end portion 312 of the lateral wall 310 of the extractor 300 may be referred to as a second protrusion portion 312.

With respect to the radial direction, the first recessed portion 211 and the second protrusion portion 312 may be located at positions corresponding to each other. The second protrusion portion 312 may be disposed in the first recessed portion 211. With respect to the radial direction, the first protrusion portion 212 and the second recessed portion 311 may be located at positions corresponding to each other. The first protrusion portion 212 may be disposed in the second recessed portion 311. The second protrusion portion 312 may overlap the first protrusion portion 212 in the radial direction.

Accordingly, the first protrusion portion 212 and the second protrusion portion 312 may support each other in the radial direction, and the lateral wall 210 of the heater holder 200 and the lateral wall 310 of the extractor 300 may be stably positioned with each other.

This is merely an example, and the form or method in which the lateral wall 210 of the heater holder 200 and the lateral wall 310 of the extractor 300 are engaged in the radial direction is not limited thereto.

As another example, coupling grooves (not shown) may be formed in opposite ends of the lateral wall 210 of the heater holder 200, and coupling protrusions (not shown) that are inserted into the coupling grooves may be formed on opposite ends of the lateral wall 310 of the extractor 300. The positions of the coupling groove and the coupling protrusion may be interchanged with each other. As another example, opposite ends of the lateral wall 210 of the heater holder 200 and opposite ends of the lateral wall 310 of the extractor 300 may be formed in diagonal lines corresponding to each other to thereby support each other in the radial direction.

FIG. 15 illustrates a cross-sectional view (a) of the embodiment of FIGS. 2 to 11 and a cross-sectional view (b) of the embodiment of FIGS. 12 to 14 for showing the comparison of the thickness of the lateral wall (21, 210) of the heater holder (20, 200) and the lateral wall (31, 310) of the extractor (30, 300), which are disposed between the induction coil 15 and the heater 50, and the distance between the heater 50 and the induction coil 15. FIG. 16 shows the comparison of power consumed to reach a predetermined temperature when the heater 50 generates heat (comparison of current consumption) and the time taken to reach a predetermined temperature when the heater 50 generates heat (comparison of temperature increase speed) between the embodiment (a) and the embodiment (b) of FIG. 15.

Referring to FIG. 15, in the case of the embodiment (a), the thickness of a wall formed by the lateral wall 21 of the heater holder 20 and the lateral wall 31 of the extractor 30, which are disposed between the induction coil 15 and the heater 50, may be defined as A2. In the case of the embodiment (b), the thickness of a wall formed by the lateral wall 210 of the heater holder 200 and the lateral wall 310 of the extractor 300, which are disposed between the induction coil 15 and the heater 50, may be defined as B2. As for the embodiment (a), the wall formed by the lateral wall 21 of the heater holder 20 and the lateral wall 31 of the extractor 30 in the radial direction is double layered, whereas as for the embodiment (b), the wall formed by the lateral wall 210 of the heater holder 200 and the lateral wall 310 of the extractor 300 in the radial direction is single layered. The thickness B2 may be less than the thickness A2. Accordingly, a distance B1 between the induction coil 15 and the heater 50 of the embodiment (b) may be less than a distance A1 between the induction coil 15 and the heater 50 of the embodiment (a).

Thus, the amount of current consumed for the heater 50 to reach the predetermined temperature when the heater 50 generates heat may be less in the case of the embodiment (b) than in the case of the embodiment (a) (see FIG. 16). In addition, the speed at which the heater 50 reaches the predetermined temperature when the heater 50 generates heat may be faster in the case of the embodiment (b) than in the case of the embodiment (a) (see FIG. 16).

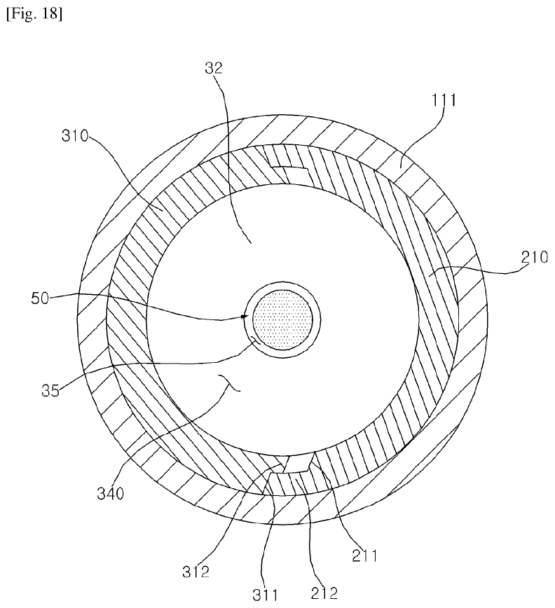

Referring to FIGS. 17 and 18, the heater holder 200 may be provided with one lateral wall 210. A first slit 214 and the lateral wall 210 of the heater holder 200 may be formed at positions opposite to each other. The extractor 300 may be provided with one lateral wall 310. A second slit 314 and the lateral wall 310 of the extractor 300 may be formed at positions opposite to each other.

The lateral wall 310 of the extractor 300 may be formed at a position corresponding to the first slit 214. The lateral wall 210 of the heater holder 200 may be formed at a position corresponding to the second slit 314. The lateral wall 310 of the extractor 300 may be disposed in the first slit 214, and the lateral wall 210 of the heater holder 200 may be disposed in the second slit 314.

Accordingly, the heater holder 200 and the extractor 300 may be more easily cleaned. In order to further improve the ease of cleaning, the first slit 214 and the second slit 314 may be open in a direction corresponding to a body wing 16.

The lateral wall 210 of the heater holder 200 and the lateral wall 310 of the extractor 300 may define a fourth insertion space 340. The lateral wall 210 of the heater holder 200 may cover one side of the fourth insertion space 340, and the lateral wall 310 of the extractor 300 may cover another side of the fourth insertion space 340. The lateral wall 210 of the heater holder 200 and the lateral wall 310 of the extractor 300 may be disposed opposite each other with respect to the fourth insertion space 340.

Referring to FIGS. 1 to 18, an aerosol generating device according to an aspect of the present disclosure includes: a body shaped to define a first insertion space that is open at a top side of the body; a heater holder comprising a lateral wall and being detachably insertable into the first insertion space; a heater coupled to the heater holder; and an extractor comprising a lateral wall and being sized to be received into the first insertion space. The lateral wall of the heater holder and the lateral wall of the extractor may collectively define a second insertion space that is open at a top side, and may be alternately disposed along a circumference of the second insertion space.

According to another aspect of the present disclosure, the extractor may be detachably insertable into the heater holder.

According to another aspect of the present disclosure, the heater holder includes a plurality of lateral walls and the extractor includes a plurality of lateral walls which collectively define the second insertion space. Each of the plurality of lateral walls of the heater holder may be alternately arranged with a corresponding one of the plurality of lateral walls of the extractor in a circumferential direction along the circumference of the second insertion space.

According to another aspect of the present disclosure, adjacent lateral walls among the plurality of lateral walls of the heater holder may be positioned to define a plurality of first slits, and adjacent lateral walls among the plurality of lateral walls of the extractor may be positioned to define a plurality of second slits, and each lateral wall of the plurality of lateral walls of the extractor may be insertable into a respective one of the plurality of first slits, and each lateral wall of the plurality of lateral walls of the heater holder may be insertable into a respective one of the plurality of second slits.

According to another aspect of the present disclosure, the lateral wall of the heater holder and the lateral wall of the extractor may engage to support each other in a radial direction.

According to another aspect of the present disclosure, the lateral wall of the heater holder may be shaped to define a first recessed portion recessed from opposite end portions thereof in a circumferential direction and in which opposite end portions of the lateral wall of the extractor are disposed, and the lateral wall of the extractor may be shaped to define a second recessed portion recessed from the opposite end portions thereof in the circumferential direction and in which the opposite end portions of the lateral wall of the heater holder are disposed. The opposite end portions of the lateral wall of the heater holder and the opposite end portions of the lateral wall of the extractor may support each other in the radial direction.

According to another aspect of the present disclosure, the lateral wall of the heater holder may cover one side of a lateral portion of the second insertion space, and the lateral wall of the extractor may cover another side of the lateral portion of the second insertion space opposite to the one side of the lateral portion.

According to another aspect of the present disclosure, the lateral wall of the heater holder and the lateral wall of the extractor may be spaced apart from a center of the second insertion space by a same distance.

According to another aspect of the present disclosure, the heater may protrude upward from a lower wall of the heater holder toward the opening of the top side of the second insertion space. A lower wall of the extractor may be positioned above the lower wall of the heater holder and may be shaped to define a through-hole through which the heater passes.

According to another aspect of the present disclosure, the lower wall of the extractor may be spaced apart from the heater around the through-hole, and may be spaced upward from the lower wall of the heater holder to form an air gap therebetween.

According to another aspect of the present disclosure, the lower wall of the heater holder may be spaced upward from a lower wall of the body that defines a lower end of the first insertion space to form an air gap therebetween.

According to another aspect of the present disclosure, an aerosol generating device may further include an upper case coupled to the extractor; and a cap coupled to the upper case and being positionable to open and close the opening of the top side of the second insertion space, wherein the upper case is detachably coupled to the body to cover one side of the body.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body shaped to define a first insertion space that is open at a top side of the body;
a heater holder comprising a lateral wall and being detachably insertable into the first insertion space;
a heater coupled to the heater holder; and
an extractor comprising a lateral wall and being detachably insertable into the first insertion space,
wherein the lateral wall of the heater holder and the lateral wall of the extractor collectively define a second insertion space that is open at a top side, and are alternately disposed along a circumference of the second insertion space.

2. The aerosol generating device of claim 1, wherein the extractor is detachably insertable into the heater holder.

3. The aerosol generating device of claim 2, wherein the heater holder includes a plurality of lateral walls and the extractor includes a plurality of lateral walls which collectively define the second insertion space,
wherein each of the plurality of lateral walls of the heater holder are alternately arranged with a corresponding one of the plurality of lateral walls of the extractor in a circumferential direction along the circumference of the second insertion space.

4. The aerosol generating device of claim 3, wherein adjacent lateral walls among the plurality of lateral walls of the heater holder are positioned to define a plurality of first slits,
wherein adjacent lateral walls among the plurality of lateral walls of the extractor are positioned to define a plurality of second slits,
wherein each lateral wall of the plurality of lateral walls of the extractor is insertable into a respective one of the plurality of first slits, and
wherein each lateral wall of the plurality of lateral walls of the heater holder is insertable into a respective one of the plurality of second slits.

5. The aerosol generating device of claim 1, wherein the lateral wall of the heater holder and the lateral wall of the extractor engage to support each other in a radial direction.

6. The aerosol generating device of claim 5, wherein the lateral wall of the heater holder is shaped to define a first recessed portion recessed from opposite end portions thereof in a circumferential direction and in which opposite end portions of the lateral wall of the extractor are disposed,
wherein the lateral wall of the extractor is shaped to define a second recessed portion recessed from the opposite end portions thereof in the circumferential direction and in which the opposite end portions of the lateral wall of the heater holder are disposed, and
wherein the opposite end portions of the lateral wall of the heater holder and the opposite end portions of the lateral wall of the extractor support each other in the radial direction.

7. The aerosol generating device of claim 1, wherein the lateral wall of the heater holder covers one side of a lateral portion of the second insertion space, and
wherein the lateral wall of the extractor covers another side of the lateral portion of the second insertion space opposite to the one side of the lateral portion.

8. The aerosol generating device of claim 1, wherein the lateral wall of the heater holder and the lateral wall of the extractor are spaced apart from a center of the second insertion space by a same distance.

9. The aerosol generating device of claim 1, wherein the heater protrudes upward from a lower wall of the heater holder toward the opening of the top side of the second insertion space, and
wherein a lower wall of the extractor is positioned above the lower wall of the heater holder and is shaped to define a through-hole through which the heater passes.

10. The aerosol generating device of claim 9, wherein the lower wall of the extractor is spaced apart from the heater around the through-hole, and is spaced upward from the lower wall of the heater holder to form an air gap therebetween.

11. The aerosol generating device of claim 10, wherein the lower wall of the heater holder is spaced upward from a lower wall of the body that defines a lower end of the first insertion space to form an air gap therebetween.

12. The aerosol generating device of claim 1, further comprising an upper case coupled to the extractor; and
a cap coupled to the upper case and being positionable to open and close the opening of the top side of the second insertion space, wherein the upper case is detachably coupled to the body to cover one side of the body.
